(19) United States
(12) Patent Application Publication
(10) Pub. No.: US 2025/0303344 A1
(43) Pub. Date: Oct. 2, 2025

(54) MATRIX TYPE ROTARY DOCKING GAS TREATMENT DEVICE

(71) Applicant: SHANGHAI SHENCHENG ENVIRONMENTAL PROTECTION EQUIPMENT & ENGINEERING CO., LTD., Shanghai (CN)

(72) Inventors: Chuanzhong ZHANG, Shanghai (CN); Shaobing DONG, Shanghai (CN); Jian CHEN, Shanghai (CN)

(21) Appl. No.: 18/851,448

(22) PCT Filed: Jan. 3, 2023
(86) PCT No.: PCT/CN2023/070210

§ 371 Date: Sep. 26, 2024

(30) Foreign Application Priority Data
Mar. 26, 2022 (CN) 202210340727.9
Mar. 26, 2022 (CN) 202210340730.0

(51) Int. Cl. B01D 53/04

(52) U.S. Cl. CPC B01D 53/0438; B01D 53/0462; B01D 2258/06

(57) ABSTRACT

The present invention relates to a device for treating organic waste gas pollutants by adopting a catalytic or adsorption concentration method, which includes a plurality of treatment units and a set of rotary regeneration device. The treatment units are arranged in a rectangular array. By arranging the positions of gas inlets and outlets of the treatment units, the gas inlets and outlets of all treatment units are respectively and uniformly distributed within two circular trajectories. The rotary regeneration device is communicated with an inlet and an outlet of each treatment unit by means of rotary docking joints. In the treatment process, working gas passes through the treatment units in parallel. A regeneration process is performed step by step. Each step simultaneously completes the heating and regeneration of a treatment agent in a regeneration treatment unit, recovery of the heat of a heat recovery treatment unit and the cooling of the treatment unit. The regeneration gas heating device is embedded in a rotary docking device. The device greatly simplifies the mechanical structure and control mode of the parallel tubular adsorption concentration device.

### TECHNICAL FIELD

The present invention relates to a gas treatment device, and further relates to a gas treatment device for treating organic waste gas pollutants by adopting a catalytic or adsorption concentration method.

### BACKGROUND ART

Patent document CN110772927A discloses a gas adsorption concentration device composed of a plurality of parallel adsorption units and a set of movable hot air regeneration device. Its positive role is to transform the regeneration process of a regenerative fixed bed adsorber from centralized regeneration that requires high power consumption to step-by-step regeneration that requires low power consumption. During the regeneration process, two adsorption units are connected in series to recover the heat absorbed by the adsorbent and the heat in the regeneration gas through heat exchange between gases, thus fully utilizing the heat energy. The movable regeneration device is composed of a hot air regeneration device and a mechanical movement device. The hot air regeneration device communicates a head end on one side of an adsorption unit group composed of two adsorption units with a regeneration gas supply device and a regeneration gas treatment device via a flexible pipeline. This part of the hot air regeneration device is called an IO end, and is communicated with two head ends on the other side of the adsorption unit group via a pipeline containing a gas heating device, which is called a CA end. Regeneration gas from the regeneration gas supply device sequentially passes through the two adsorption units of the adsorption unit group and reaches the regeneration gas treatment device. The mechanical movement device supports the hot air regeneration device and sequentially completes the connection and switching between the regeneration device and each adsorption unit group under controlled power drive.

In practice, the mechanical movement device requires to support at least eight controlled movements on both sides, including horizontal movements, vertical movements and rotations of the IO end and the CA end, and attachment and detachment of the IO end and the CA end with the adsorption units, in the process of sequentially completing the connection and switching between the IO end/CA end and each adsorption unit group. The complexity of these controlled movements and the precision of manufacturing control make the manufacturing cost of the device always high. The operational reliability poses a significant challenge to the manufacturing, operation and maintenance of equipment.

### SUMMARY OF INVENTION

The present invention improves the mechanical structure and control mode of the mechanical movement device in the technical solution above, and upgrades its regeneration process mechanism, thus reducing the number of controlled movements, simplifying the movement control mode, reducing the cost of equipment, and enhancing the operational reliability of equipment.

This device may also be used for ambient temperature catalytic treatment of organic polluting gases. When organic polluting gases pass through the device, they are catalyzed by a catalyst to produce non-toxic, harmless or low toxic substances, which are then discharged. The form and loading manner of the catalyst are the same as or similar to those of the adsorbent, and the catalytic process is similar to the adsorption process. Pollutants generally do not remain in the catalyst for a long time, but the pollutants themselves or other trace harmful substances accompanying the catalytic effect will cause deactivation of the catalyst. This deactivation can be eliminated by heating to remove harmful substances from the catalyst and restore its original catalytic activity. The process of catalyst heating to restore catalytic activity is similar to the process of adsorbent regeneration to restore adsorption activity, and the two treatment processes can be collectively referred to as regeneration. Corresponding catalytic and adsorption processes for polluting gases are collectively referred to as treatment process. Treatment methods for harmful gases generated in adsorbent regeneration and catalyst regeneration may also adopt similar treatment processes. Polluted gases are referred to as working gas here, and regeneration or regeneration treatment gas is referred to as regeneration gas.

The present invention specifically adopts the following technical solution: a gas treatment device includes a housing, a working gas inlet, a working gas outlet, a plurality of treatment units, and a set of rotary regeneration device. Each treatment unit is equivalent to a small fixed bed treater. All treatment units are arranged in a rectangular array and connected by a supporting and connection structure to form a closed treatment core, so that working gas entering the housing from the working gas inlet passes through the treatment units on the treatment core and reaches the working gas outlet. The rectangular array here is borrowed from the operation commands of drawing software. In a regeneration process, regeneration gas from the regeneration gas supply device heats and regenerates a treatment agent in a regeneration treatment unit group comprising at least one treatment unit, recovers heat absorbed by a treatment agent in a heat recovery treatment unit group comprising at least one treatment unit in the regeneration process at the same time, and cools the treatment unit group. A regeneration gas heating device is embedded in a rotary docking device, which completes connection and switching between the rotary regeneration device and each treatment unit group by means of detachment, rotation and docking actions under controlled power drive.

When implementing the solution, by arranging the positions of the gas inlets and outlets of the treatment units at different parts, the gas inlets and outlets of all treatment units arranged in an array are respectively and uniformly distributed in two circular trajectories. Rotary docking devices on two sides can synchronously rotate through mechanical connection and complete the docking and detachment between the rotary regeneration device and each treatment unit during regeneration treatment with axial extension and retraction actions.

Each treatment unit may be arranged in a cuboid shape. The treatment agent is granular. Two layers of sieve plates divide the space inside the treatment unit into three parts from top to bottom, namely an upper gas channel, a packing chamber and a lower gas channel. A packing agent is filled in the packing chamber. The working gas passes through the packing chamber from bottom to top during a treatment operation. The regeneration gas passes through the packing chamber from top to bottom during a regeneration operation.

The housings of all treatment units, including the gas inlets and outlets, are arranged according to the same structure. The number of the treatment units is six or eight. The treatment units are arranged in an array of 2*3 or 2*4. The transformation between configurations that one identical structural housing corresponds to different positions is achieved by means of rotary arrangements in up-down, left-right and front-rear perpendicular directions. In this way, the number of molds used for molding the treatment units during mass production can be reduced.

In another aspect, the present invention specifically adopts the following technical solution: a gas treatment device includes a housing, a working gas inlet, a working gas outlet, a plurality of treatment units, and a set of rotary regeneration device. Each treatment unit is equivalent to a small fixed bed adsorber. All treatment units are arranged in a rectangular-like array and connected by a supporting and connection structure to form a closed treatment core, so that working gas entering the housing from the working gas inlet passes through the treatment units on the treatment core and reaches the working gas outlet. The rectangular-like array here is borrowed from the operation commands of drawing software, where the meaning of “like” refers to the overall arrangement. The number of individuals contained in each row and column may not be strictly the same. For example, for the sake of functional design, individuals in the middle or four corner positions are intentionally made vacant. The rotary regeneration device is composed of a regeneration gas supply device, a regeneration gas heating device, and a rotary docking device. The rotary docking device includes a regeneration gas A-side rotary docking joint, a treatment unit inlet and outlet transformation device, and a regeneration gas B-side rotary docking joint. The function of the treatment unit gas inlet and outlet transformation device is to communicate the gas inlets and outlets of the treatment units arranged in a rectangular-like array with two circular trajectories uniformly arranged and respectively corresponding to the regeneration gas A-side rotary docking joint and the regeneration gas B-side rotary docking joint. The specific solution may be as follows: one ends of a plurality of pipelines with different lengths and shapes are connected to the gas inlet and outlet ends of the treatment unit, and the other ends are sequentially opened in two circular trajectories respectively corresponding to the regeneration gas A-side rotary docking joint and the regeneration gas B-side rotary docking joint. Further, the openings of the pipelines within the two circular trajectories may be integrally connected by using a circular disc. The rotary docking joints on two sides can rotate synchronously through mechanical connection. In a regeneration process, regeneration gas from the regeneration gas supply device heats and regenerates a treatment agent in a regeneration treatment unit group including at least one treatment unit, recovers heat absorbed by a treatment agent in a heat recovery treatment unit group including at least one treatment unit in the regeneration process at the same time, and cools the treatment unit group. The regeneration gas heating device is embedded in the rotary docking device, which completes connection and switching between the rotary regeneration device and each treatment unit group through detachment, rotation and docking actions under controlled power drive.

Each of the regeneration treatment unit group and the heat recovery treatment unit group may include only one treatment unit.

When the regeneration treatment unit group includes two or more treatment units, the waste gas concentration ratio in the regeneration process of the device can be increased, and the thermal utilization efficiency in the regeneration process of the device can also be improved.

When the heat recovery treatment unit group includes two or more treatment units, the heat utilization efficiency in the regeneration process of the device can be improved, and it also has a positive effect on the regeneration depth of the device to the treatment agent.

Large-sized resistance reducing valves are arranged at two ends of each treatment unit, thus eliminating the need for the working gas to pass through a regeneration gas A-side branch connection device and a regeneration gas B-side branch connection device during treatment operations, and reducing the air resistance of the working gas.

The flow direction of the regeneration gas during the regeneration process may be optimized through connection pipelines connected on A and B sides, thus achieving a full downstream regeneration or cooling combined regeneration effect

The regeneration gas heating function may be transferred to an external RTO device for treating regeneration gas through a pipeline. When treating polluting gases containing VOCs with high calorific value, the excess heat generated by pyrolysis of VOCs may be used for heating the regeneration gas.

The present invention has the following positive effects:
(1) Compared with the parallel tubular gas adsorption concentration device before improvement, the mechanical structure and control mode of the movable desorption device is simplified. The mechanical driving device for the rotating shaft can be arranged outside the gas path, thus avoiding corrosion caused by high-humidity and high-temperature gases in the waste gas environment.
(2) The “low-temperature in and low-temperature out” multi-stage desorption of desorption gas is achieved, which has dual effects of improving concentration ratio and reducing desorption energy consumption.
(3) A shorter hard tube is easy to solve the problem of high-temperature gas supply when using waste heat of pyrolysis of VOCs through RTO as a desorption heat source.

The present invention will be further described below in combination with the embodiments with reference to the accompanying drawings.

### BRIEF DESCRIPTION OF THE DRAWINGS

FIG. 1 illustrates a schematic diagram of a waste gas treatment function of a modular matrix type rotary docking gas treatment device.

FIGS. 2A-2B illustrate a schematic diagram of connection structures and functions of regeneration pipelines of a modular matrix type rotary docking gas treatment device, which totally show two steps.

FIG. 3 illustrates a schematic structural diagram of an A-side rotary docking device according to an embodiment in which there are six treatment units.

FIG. 4 illustrates a schematic structural diagram of an B-side rotary docking device according to an embodiment in which there are six treatment units.

FIG. 5 illustrates a schematic diagram of imaginary rotation axes in three perpendicular spatial directions of treatment units.

FIG. 6 illustrates a schematic structural diagram of an A-side rotary docking device according to an embodiment in which there are eight treatment units.

FIG. 7 illustrates a schematic structural diagram of an B-side rotary docking device according to an embodiment in which there are eight treatment units.

FIG. 8 illustrates a schematic diagram of connection functions of regeneration pipelines of a modular rotary docking gas treatment device.

FIG. 9A illustrates a schematic diagram of connection structures of A-side regeneration pipelines of the device in FIG. 8.

FIG. 9B illustrates a schematic diagram of connection structures of B-side regeneration pipelines of the device in FIG. 8.

FIG. 10 illustrates a schematic diagram of an improved function of the device in FIG. 8, where resistance reducing valves are added.

FIG. 11 illustrates a schematic diagram of functions of the device in FIG. 10, where advanced regeneration and advanced heat recovery functions are configured, with priority given to cooling effect.

FIG. 12A illustrates a schematic diagram of connection functions and structures of A-side regeneration pipelines of the device in FIG. 11.

FIG. 12B illustrates a schematic diagram of connection functions and structures of B-side regeneration pipelines of the device in FIG. 11.

FIG. 13 illustrates a 3D schematic structural diagram of the device in FIG. 11 on regeneration gas input and output sides.

FIG. 14 illustrates a 3D schematic structural diagram of the device in FIG. 11 on a regeneration gas heating side.

FIG. 15A illustrates a schematic diagram of mechanical transmission of a resistance reducing valve.

FIG. 15B illustrates a partial enlarged schematic diagram of mechanical transmission of a resistance reducing valve, where a movement trajectory of a forced sealing mechanical structure of the resistance reducing valve is shown.

FIG. 16 illustrates a schematic diagram of a force applying and sealing mechanical structure of a resistance reducing valve in opened and closed states.

FIG. 17 illustrates a schematic diagram of functions of the device in FIG. 10, where advanced regeneration and advanced heat recovery functions are configured, with priority given to regeneration depth.

FIG. 18 illustrates a schematic diagram of a function of the device in FIG. 11, where a function of using RTO waste heat as a regeneration gas heat source is added.

### DETAILED DESCRIPTION OF PREFERRED EMBODIMENTS

### Embodiment 1: Modular Matrix Type Rotary Docking Gas Treatment Device with Six Treatment Units

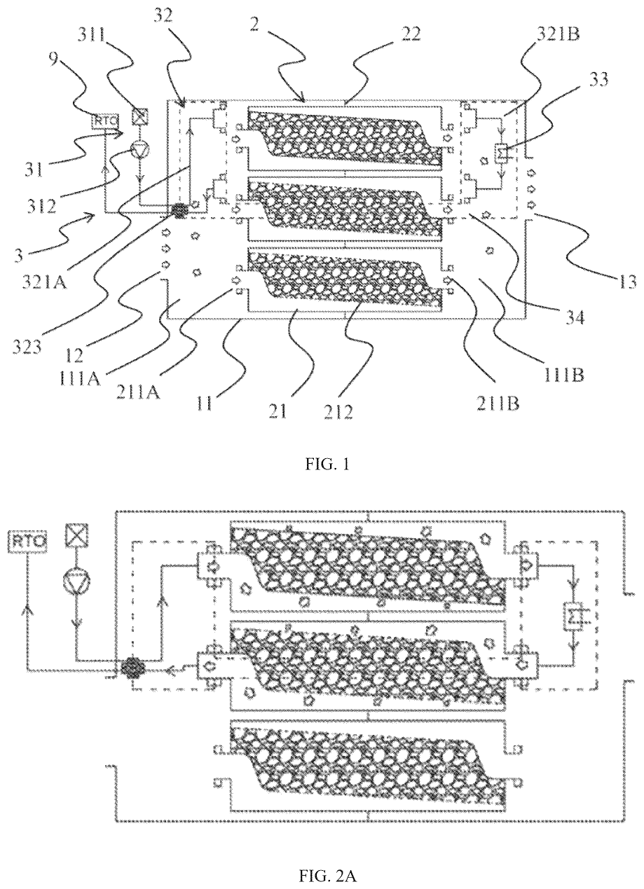

Referring to FIG. 1, the device includes a housing 11, a working gas inlet 12, a working gas outlet 13, six treatment units 21, and a set of rotary regeneration device 3. Each treatment unit 21 is equivalent to a small fixed bed adsorber. All treatment units are arranged in a rectangular array and connected by a supporting and connection structure 22 to form a closed treatment core 2. During treatment operations, working gas entering the housing from the working gas inlet 12 passes through the treatment units 21 on the treatment core 2 and reaches the working gas outlet 13.

The rotary regeneration device 3 is composed of a regeneration gas supply device 31, a rotary docking device 32 and a regeneration gas heating device 33. The regeneration gas supply device 31 includes an air filtration device 311 and a regeneration fan 312. The rotary docking device 32 includes a regeneration gas A-side rotary docking joint 321A and a regeneration gas B-side rotary docking joint 321B. The rotary docking joints on two sides are connected via a connecting shaft 34 and rotate synchronously. The regeneration gas supply device 31 and the regeneration gas treatment device 9 are connected to the regeneration gas A-side rotary docking joint 321A through a coaxial rotary joint 323. The regeneration gas treatment device 9 here is described by taking RTO as an example, which belongs to a peripheral supporting device of the modular rotary docking gas treatment device.

Here, description is made by taking adsorption treatment as an example. During an adsorption operation, the regeneration gas A-side rotary docking joint 321A and the regeneration gas B-side rotary docking joint 321B are detached from gas inlets 211A and gas outlets 211B of respective treatment units. The working gas enters a static pressure box 111A in the housing 11 through the working gas inlet 12, enters the six treatment units 21 in parallel through the gas inlets 211A of the treatment units, and passes through treatment agent packing layers 212 in the treatment units 21. Pollutants remain in the treatment agent. Clean working gas leaves the treatment units 21, enters a collection box 111B through the gas outlets 211B, and finally is discharged out of the entire device through the working gas outlet 13, thus completing the adsorption process.

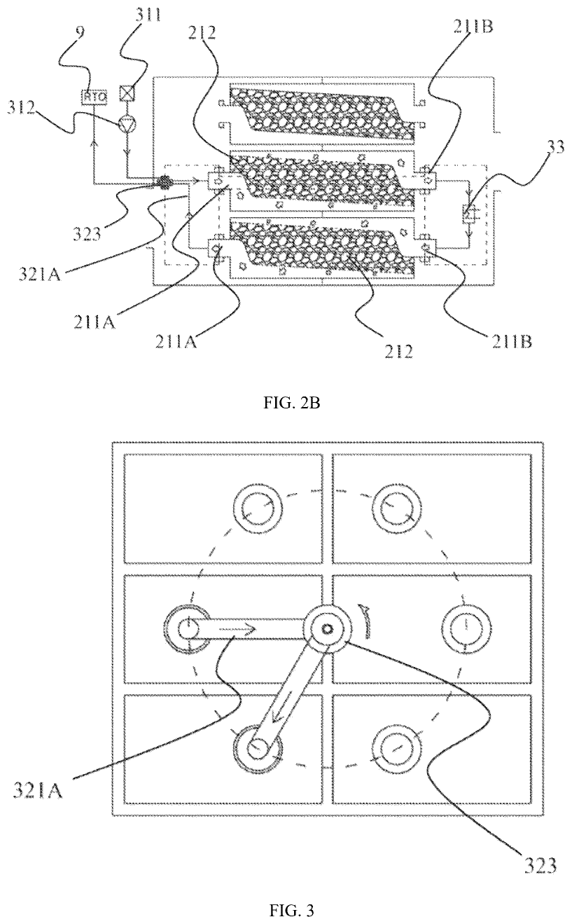

Referring to FIGS. 2A-2B, during the regeneration operation, the first treatment unit does not have a heat recovery function. Starting from the second treatment unit, the regeneration gas enters the heat recovery treatment unit through the air filtration device 311, the regeneration fan 312, the coaxial rotary joint 323, the regeneration gas A-side rotary docking joint 321A and the gas inlet 211A, is preheated by a packing 212 in the heat recovery treatment unit, enters the B-side rotary docking joint 321B and the regeneration gas heating device 33 embedded therein through the gas outlet 211B, enters the regeneration treatment unit again through the working gas outlet 211B to heat and regenerate the treatment agent packing 212 in the regeneration treatment unit, carries desorbed pollutants through the gas inlet 211A to the A-side rotary docking joint 321A again, and is discharged to the regeneration gas treatment device 9 through the coaxial rotary joint 323A.

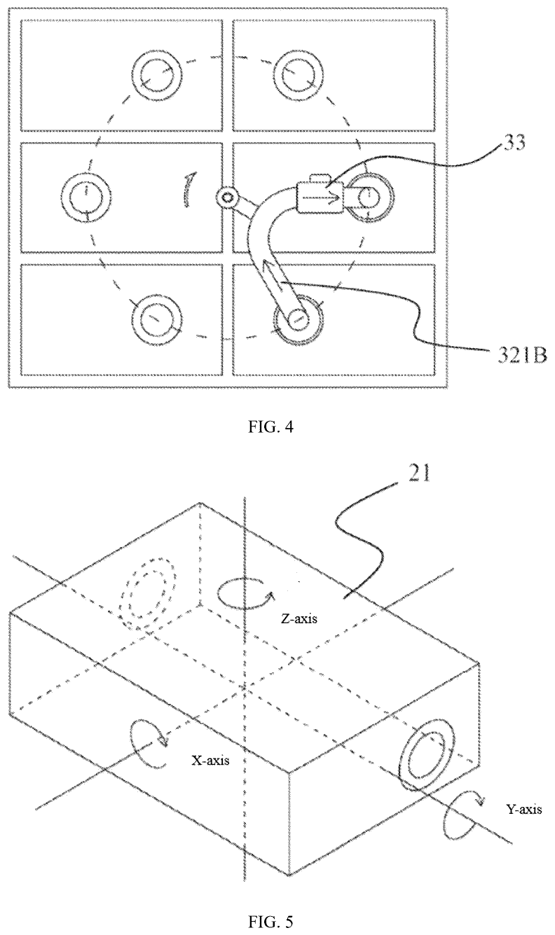

Referring to FIGS. 3-4, the regeneration gas completes the heating and regeneration of the treatment agent in the regeneration treatment unit, recovers the heat absorbed by the treatment agent in the heat recovery treatment unit in the regeneration process at the same time, and cools the treatment unit. The rotary docking joints 321A and 321B on two sides complete connection and switching between the rotary regeneration device 3 and each treatment unit by means of detachment, rotation and docking actions under controlled power drive. The B-side rotary docking joint 321B is connected to and supports the regeneration gas heating device 33. The regeneration gas heating device 33 moves synchronously with the B-side rotary docking joint 321B.

Referring to FIGS. 3-5, in this embodiment, the housings of the six treatment units, including the gas inlets and outlets, are arranged in an array of 2*3 according to the same structure. The transformation between them can be achieved via 1800 rotation in the Y-axis direction, that is, reverse rotation in the up-down direction.

### Embodiment 2: Modular Matrix Type Rotary Docking Gas Treatment Device with Eight Treatment Units

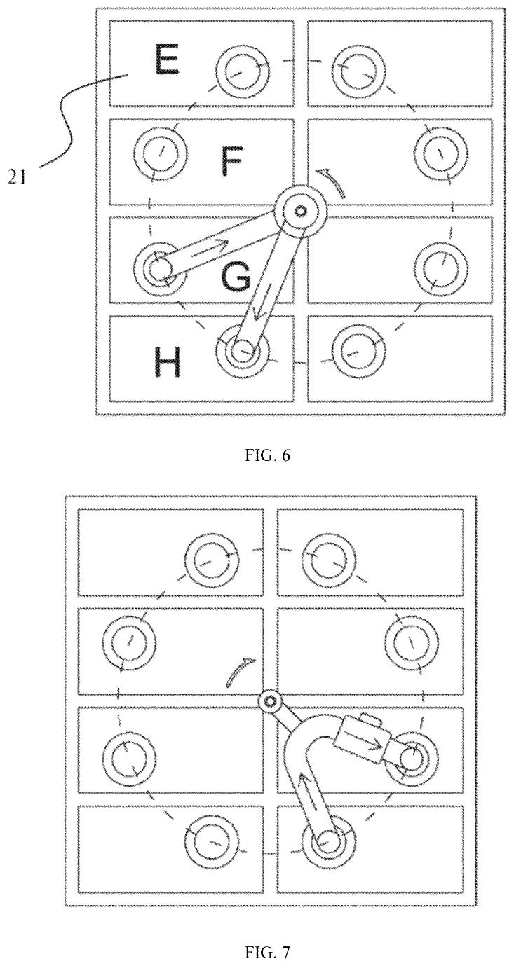

Referring to FIGS. 5-7, in this embodiment, the device includes eight treatment units 21, and other arrangements are the same as those of the device in embodiment 1.

In this embodiment, the housings of the eight treatment units 21, including the gas inlets and outlets, are arranged in an array of 2*4 according to the same structure. The transformation between them can be achieved via 1800 rotation in the X-axis, Y-axis and Z-axis directions, that is, reverse rotation in the up-down, left-right and front-rear directions.

For example, the four treatment units 21 on the left side are marked as E, F, G, and H, respectively. The treatment unit E can be transformed to F by rotating 1800 along the Y-axis, can be transformed to G by rotating 1800 along the Z-axis, and can be transformed to H by rotating 1800 along the X-axis. The four units on the right side can also be transformed in this way.

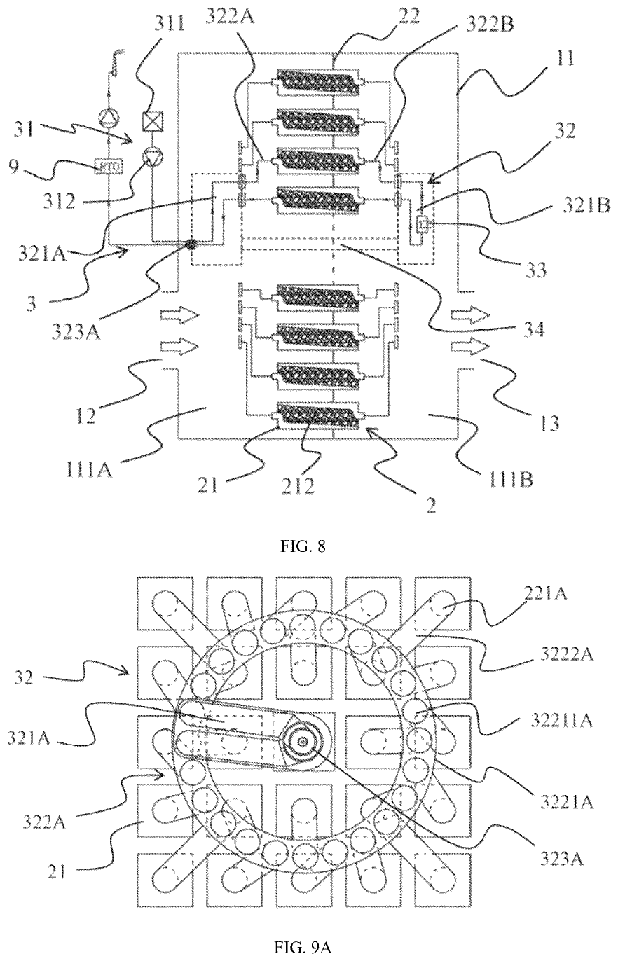

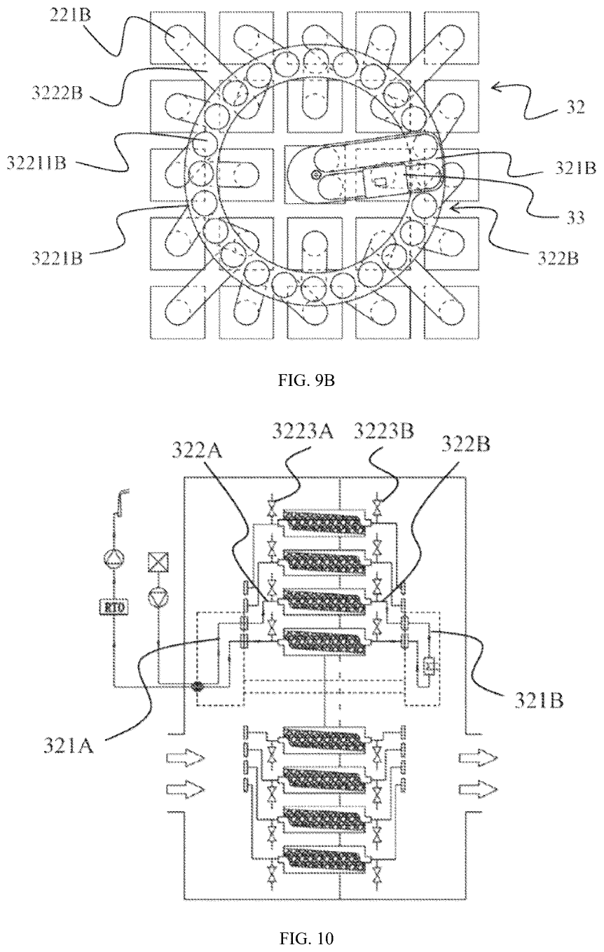

### Embodiment 3: Basic Model of Modular Rotary Docking Gas Treatment Device (Refer to FIGS. 8, 9a and 9b)

Referring to FIG. 8, a gas treatment device includes a housing 11, a working gas inlet 12, a working gas outlet 13, twenty-four treatment units 21, and a set of rotary regeneration device 3. Each treatment unit 21 is equivalent to a small fixed bed adsorber. All treatment units are arranged in a rectangular-like array and connected by a supporting and connection structure 22 to form a closed adsorption core 2, so that working gas entering the housing from the working gas inlet 12 passes through the treatment units 21 on the treatment core 2 and reaches the working gas outlet 13.

Referring to FIGS. 8, 9A and 9B, the rotary regeneration device 3 is composed of a regeneration gas supply device 31, a rotary docking device 32 and a regeneration gas heating device 33. The regeneration gas supply device 31 includes an air filtration device 311 and a regeneration fan 312. The rotary docking device 32 includes a regeneration gas A-side rotary docking joint 321A, a regeneration gas A-side branch connection device 322A, a regeneration gas B-side branch connection device 322B, and a regeneration gas B-side rotary docking joint 321B. The rotary docking joints on two sides are connected via a connecting shaft 34 and rotate synchronously. Each of the regeneration gas A-side branch connection device 322A and the regeneration gas B-side branch connection device 322B includes a circular docking disc 3221A, 3221B. Each circular docking disc is provided with twenty-four docking openings 32211A, 32211B. Each docking opening is communicated with the gas inlet and outlet 211A, 211B of the corresponding treatment unit through a respective branch connection pipe 3222A, 3222B. The regeneration gas supply device 31 and the regeneration gas treatment device 9 are connected to the regeneration gas A-side rotary docking joint 321A through a coaxial rotary joint 323. The regeneration gas treatment device 9 here is described by taking RTO as an example, which belongs to a peripheral supporting device of the modular rotary docking gas treatment device.

Here, description is made by taking adsorption treatment as an example. During an adsorption operation, the regeneration gas A-side rotary docking joint 321A and the regeneration gas B-side rotary docking joint 321B are detached from respective corresponding circular docking disc 3221A, 3221B. The working gas enters a static pressure box 111A in the housing 11 through the working gas inlet 12, enters the twenty-four treatment units 21 in parallel through the regeneration gas A-side branch connection device 322A, and passes through treatment agent packing layers 212 in the treatment units. Pollutants remain in the treatment agent. Clean working gas leaves the treatment units 21, enters a collection box 111B through the regeneration gas B-side branch connection device 322B, and finally is discharged out of the entire device through the working gas outlet 13, thus completing the adsorption process.

During the regeneration operation, the regeneration gas enters the heat recovery treatment unit group through the air filtration device 311, the regeneration fan 312, the coaxial rotary joint 323A, the regeneration gas A-side rotary docking joint 321A and the regeneration gas A-side branch connection device 322A, is preheated by a packing 212 in the heat recovery treatment unit group, enters the regeneration gas B-side branch connection device 322B, passes through the regeneration gas B-side rotary docking joint 321B and the regeneration gas heating device 33 embedded therein, enters the regeneration treatment unit group again through the other connection pipeline of the regeneration gas B-side branch connection device 322B to heat and regenerate the treatment agent packing 212 in the regeneration treatment unit group, carries desorbed pollutants to enter the regeneration gas A-side branch connection device 322A and the regeneration gas A-side rotary docking joint 321A again, and is discharged to the regeneration gas treatment device 9 through the coaxial rotary joint 323A.

The regeneration gas completes the heating and regeneration of the treatment agent in the regeneration treatment unit group, recovers the heat absorbed by the treatment agent in the heat recovery treatment unit group in the regeneration process at the same time, and cools the treatment unit group. The rotary docking joints 321A and 321B on two sides complete connection and switching between the rotary regeneration device 3 and each treatment unit group by means of detachment, rotation and docking actions under controlled power drive. The B-side rotary docking joint 321B is connected to and supports the regeneration gas heating device 33. The regeneration gas heating device 33 moves synchronously with the B-side rotary docking joint 321B.

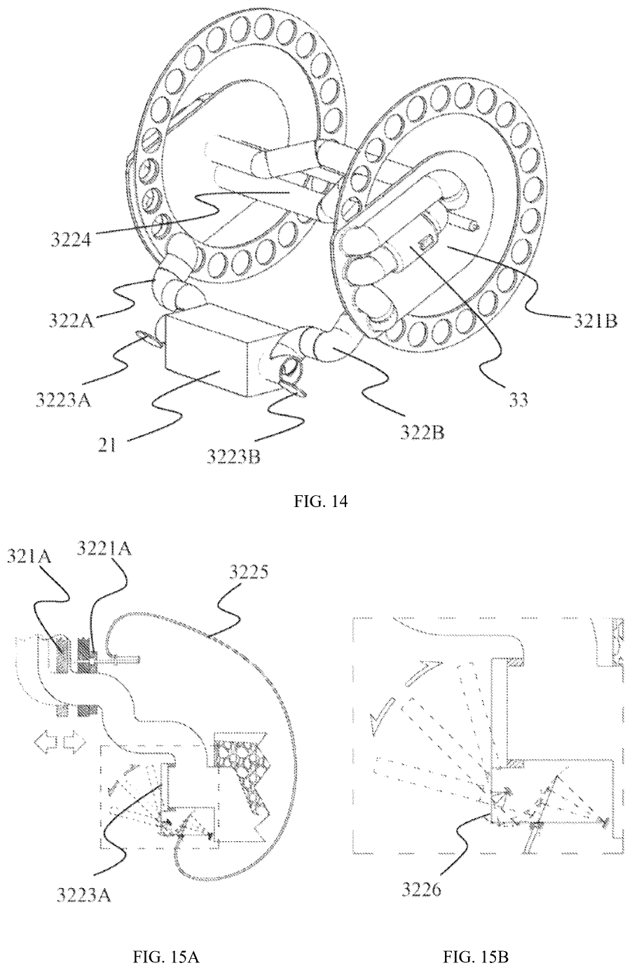

### Embodiment 4: Improved Model of Modular Rotary Docking Gas Treatment Device Added with Resistance Reducing Valves (Refer to FIGS. 10 and 14)

On the basis of embodiment 3, in order to reduce the air resistance when the working gas passes through the regeneration gas branch connection devices 322A and 322B on A and B sides during the adsorption operation, and to reduce the airflow imbalance caused by the connection pipelines with different lengths corresponding to each treatment unit, resistance reducing valves 3223A and 3223B are arranged at the inlet and outlet of each treatment unit. The valves are controlled to close during the regeneration operation of the corresponding treatment unit and open at other times.

The resistance reducing valves can be controlled separately by a main control. The two valves corresponding to each treatment unit may be grouped together and synchronously controlled as a control point.

A better control method for the resistance reducing valves is to synchronize the opening and closing actions of the valves with the mechanical device of the detachment, rotation and docking action of the rotary docking joints 321A and 321B on two sides, so that the control of the resistance reducing valves does not require the addition of separate control points. The specific implementation solution of this control method will be introduced in detail in the following embodiments.

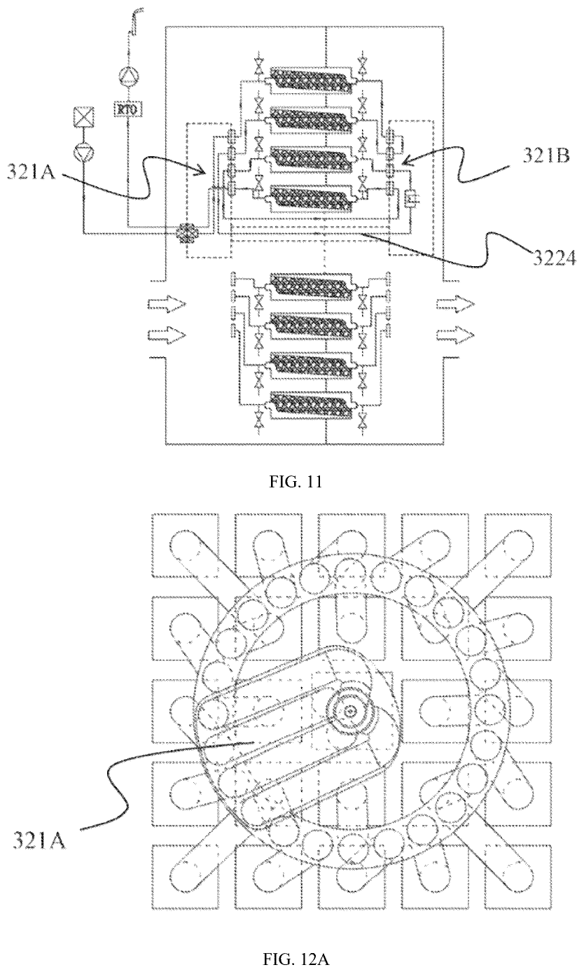

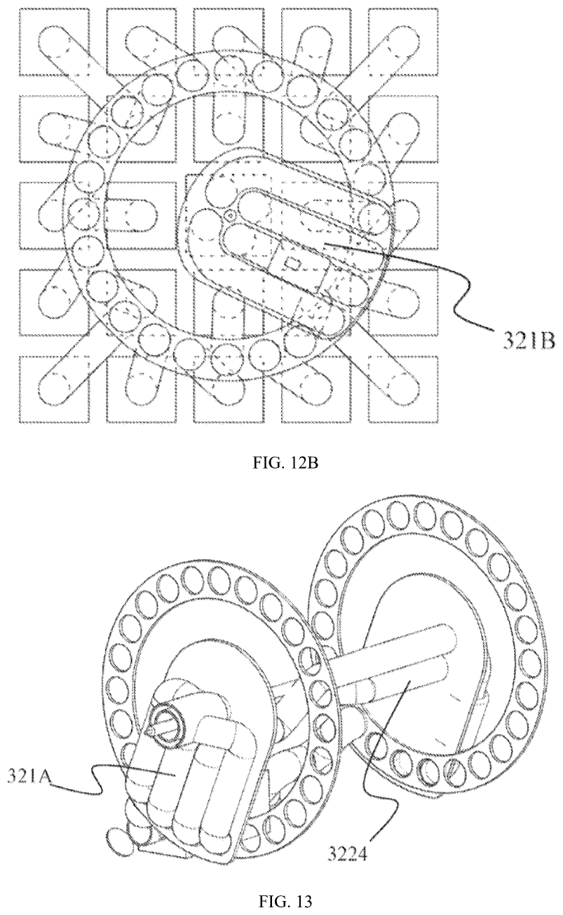

Embodiment 5: Improvement of Modular Rotary Rocking Gas Treatment Device in Embodiment 4, which Achieves Advanced Regeneration and Advanced Heat Recovery Functions, as Well as a Cooling Effect Priority Mode (Refer to FIGS. 11, 12a-12b, 13-14, 15a-15b, and 16)

Each of the regeneration treatment unit group and the heat recovery treatment unit group is provided with two treatment units. A connection pipeline 3224 which can rotate synchronously and can be extended and retracted is arranged between the rotary docking joints 321A and 321B on two sides. The extension and retraction of the connection pipeline 3224 can be achieved by using a bellows expansion joint or sealed telescopic sleeve. Referring to FIGS. 11 and 13-14.

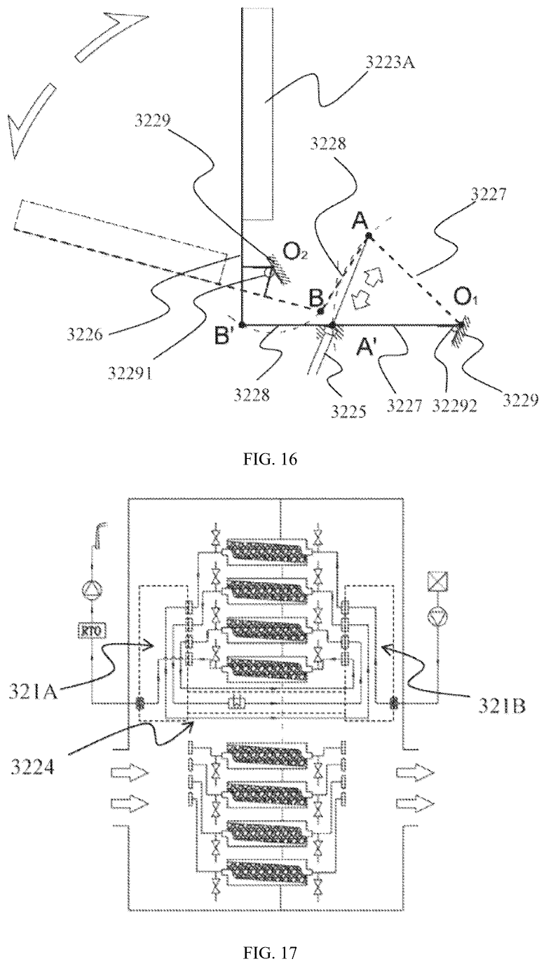

The control methods of the resistance reducing valves 3223A and 3223B will be described here in detail. Referring to FIGS. 15A-15B and 16.

In this embodiment, each step of the regeneration operation involves four treatment units and eight resistance reducing valves in total. The eight resistance reducing valves need to complete the closing actions of the resistance reducing valves while completing the docking with the docking openings corresponding to the docking discs 3221A, 3221B at the rotary docking joints 321A and 321B.

In this embodiment, a mechanical transmission device that synchronizes the mechanical devices for the opening and closing actions of the resistance reducing valves 3223A, 3223B and for the detachment, rotation and docking actions of the rotary docking joints 321A and 321B on two sides adopts a power transmission line 3225. The opening and closing actions of the resistance reducing valves themselves are completed by a T-shaped rocker 3226. The stretching action transmitted by the power transmission line is converted into the rotational motion of the resistance reducing valves by means of a planar hinge four-linkage mechanism composed of another rocker 3227, a connecting rod 3228 and a frame 3239. The dead point is used to form a force increasing transmission mechanism that works when the valves are closed, making the valves to achieve pressurized sealing. As an alternative solution, the transmission function of the power transmission line 3225 may also be achieved by other commonly used mechanical transmission means such as connecting rods, cables and flexible transmission shafts. The frame 3239 is represented here by two ground connection planes.

Referring to FIG. 16, more specifically, the rotation fulcrum of the T-shaped rocker connected with the resistance reducing valve is O₂, and return spring 32291 is arranged at O₂. The rotation fulcrum of the rocker 3227 is O₁, and a return spring 32292 is also arranged at this position. The connecting rod 3228 is connected with two rocker arms via two rotating pairs. The two rotation fulcrum O₁ and O₂ form the frame of the planar hinge four-linkage mechanism. Curve O₁AB shows that the valve is in an open state. Line O₁A′B′ shows that the planar hinge four-linkage mechanism is in a dead point state, and the valve is in a forced closed state.

### Embodiment 6: Another Embodiment of Modular Rotary Docking Gas Treatment Device in Embodiment 5, which Achieves a Regeneration Depth Priority Mode or Full Downstream Mode (Refer to FIG. 17)

On the basis of embodiment 5, the connection manner of the connection pipeline 3224 which rotates synchronously and is arranged between the rotary docking joints 321A and 321B on two sides is adjusted, so that the airflow directions of the regeneration gas in the regeneration treatment unit group and the heat recovery treatment unit group are consistent.

The modular rotary docking gas treatment device in this embodiment has particularly significant technical advantages when used for treating components with high concentrations of VOCs. The device achieves advanced regeneration and advanced heat recovery functions that can further improve the concentration ratio of waste gas and reduce the consumption of regeneration heat energy. This structure can keep the regeneration gas in a low-temperature state when it is discharged out of the gas treatment device and enters the RTO device.

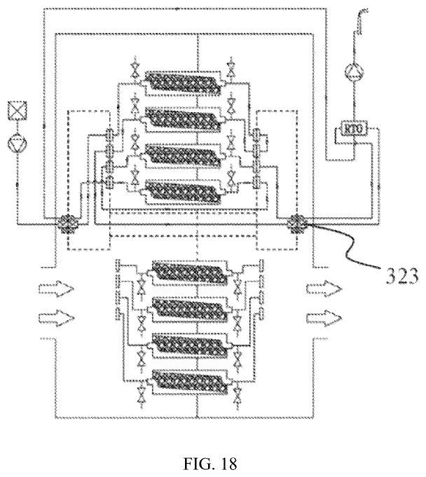

### Embodiment 7: Improvement of Modular Rotary Docking Gas Treatment Device in Embodiment 6 Added with Function of Using RTO Waste Heat as Regeneration Gas Heat Source (Refer to FIG. 18)

On the basis of embodiment 5, another coaxial rotary joint 323B is added on the B side of the device. The regeneration gas preheated by the heat recovery treatment unit group is introduced into the RTO via two pipelines. The excess heat generated in the pyrolysis of the regeneration gas by means of the RTO, except the heat for maintaining the thermal balance of the RTO itself, is used for heating the regeneration gas, which is then sent to the regeneration treatment unit group via pipelines.

1. A gas treatment device, comprising a housing, a working gas inlet, a working gas outlet, a plurality of treatment units, and a set of rotary regeneration device,
each treatment unit being a small fixed bed treater, all treatment units being arranged in a rectangular array and connected by a supporting and connection structure to form a closed treatment core, so that working gas entering said housing from said working gas inlet passes through said treatment units on said treatment core and reaches said working gas outlet;
said rotary regeneration device being composed of a regeneration gas supply device, a regeneration gas heating device and a rotary docking device;
in a regeneration process, regeneration gas from said regeneration gas supply device heating and regenerating a treatment agent in a regeneration treatment unit group comprising at least one treatment unit, recovering heat absorbed by a treatment agent in a heat recovery treatment unit group comprising at least one treatment unit in the regeneration process at the same time, and cooling said treatment unit group;
said regeneration gas heating device being embedded in said rotary docking device, which completes connection and switching between said rotary regeneration device and each treatment unit group by means of detachment, rotation and docking actions under controlled power drive.

2. The gas treatment device according to claim 1, wherein by arranging the positions of said gas inlets and outlets of said treatment units, said gas inlets and outlets of all treatment units are respectively and uniformly distributed within two circular trajectories, and each of said regeneration treatment unit group and said heat recovery treatment unit group only comprises one treatment unit.

3. The gas treatment device according to claim 2, wherein said housings of all treatment units, including said gas inlets and outlets, are arranged according to the same structure.

4. The gas treatment device according to claim 3, wherein the number of said treatment units is six, said treatment units are arranged in an array of 2*3, and transformation between configurations that one identical structural housing corresponds to different positions is achieved by means of up-down reverse arrangements.

5. The gas treatment device according to claim 3, wherein the number of said treatment units is eight, said treatment units are arranged in an array of 2*4, and the transformation between configurations that one identical structural housing corresponds to different positions is achieved by means of rotary arrangements in up-down, left-right and front-rear perpendicular directions

6. The gas treatment device according to claim 1, wherein said rotary docking device comprises a regeneration gas A-side rotary docking joint, a treatment unit gas inlet and outlet transformation device, and a regeneration gas B-side rotary docking joint, the function of said treatment unit gas inlet and outlet transformation device is to communicate said gas inlets and outlets of said treatment units arranged in a rectangular-like array with two circular trajectories uniformly arranged and respectively corresponding to said regeneration gas A-side rotary docking joint and said regeneration gas B-side rotary docking joint.

7. The gas treatment device according to claim 6, wherein said treatment unit gas inlet and outlet transformation device comprises a regeneration gas A-side branch connection device and a regeneration gas B-side branch connection device.

8. The gas treatment device according to claim 7, wherein each of said regeneration treatment unit group and said heat recovery treatment unit group comprises only one treatment unit.

9. The gas treatment device according to claim 7, wherein each of said regeneration treatment unit group and said heat recovery treatment unit group comprises 1 to 2 treatment units.

10. The gas treatment device according to claim 7, wherein resistance reducing valves are arranged at two ends of each treatment unit.

11. The gas treatment device according to claim 10, wherein opening and closing actions of said resistance reducing valves are synchronously controlled by said rotary docking device group by group.

12. The gas treatment device according to claim 11, wherein the opening and closing actions of said resistance reducing valves are achieved through a planar hinge four-linkage mechanism.

13. The gas treatment device according to claim 10, wherein full downstream regeneration or cooling combined regeneration is achieved via connection pipelines connected on A-side and B-side.

14. The gas treatment device according to claim 1, wherein each treatment unit is arranged in a cuboid shape, said treatment agent is granular, two layers of sieve plates divide the space inside said treatment unit into three parts from top to bottom, namely, an upper gas channel, a packing chamber and a lower gas channel, a packing agent is filled in said packing chamber, the working gas passes through said packing chamber from bottom to top during a treatment operation, and the regeneration gas passes through said packing chamber from top to bottom during a regeneration operation.

15. The gas treatment device according to claim 1, wherein the regeneration gas is heated and transferred via a pipeline to an external RTO device for treating the regeneration gas.
